(19) United States
(12) Patent Application Publication
(10) Pub. No.: US 2012/0206082 A1
(43) Pub. Date: Aug. 16, 2012

(54) MULTI-PHASE OUTER-ROTOR-TYPE VARIABLE FREQUENCY INDUCTION MOTOR FOR A CEILING FAN

(75) Inventors: Kuo-Hua Huang, Taichung City (TW); Ming-Chin Tseng, Taichung City (TW); Chao-Pi Chang, Nantou County (TW)

(73) Assignee: BIGBEST SOLUTIONS, INC.

(21) Appl. No.: 13/165,881

(22) Filed: Jun. 22, 2011

(30) Foreign Application Priority Data
Feb. 15, 2011 (TW) 100202768

(51) Int. Cl. H02P 27/04

(52) U.S. Cl. 318/807

(57) ABSTRACT

A multi-phase outer-rotor-type variable frequency induction motor for a ceiling fan includes: an outer rotor disposed in a housing that includes a plurality of blade-mounting parts, and including a stator-mounting part that is surrounded by an outer rotor body which is combined with the housing, the outer rotor body being formed with a plurality of slots in which conductive elements are respectively disposed; a stator disposed in the stator-mounting part, and including a central shaft pivotally connected to the housing, a stator core extending in radial directions from the central shaft, and a winding set that is disposed to wind in winding slots formed in the stator core, and that is configured into a multi-phase winding arrangement; and a control unit operable to control frequency of a power signal fed by the control unit to the winding set.

### CROSS-REFERENCE TO RELATED APPLICATION

This application claims priority of Taiwanese Application No. 100202768, filed on Feb. 15, 2011.

### BACKGROUND OF THE INVENTION

1. Field of the Invention

The present invention relates to an induction motor for a ceiling fan, more particularly to a multi-phase outer-rotor-type variable frequency induction motor for a ceiling fan.

2. Description of the Related Art

Ceiling fans generally adopt an alternating-current single-phase squirrel-cage induction motor mechanism. Referring to FIG. 1, a squirrel-cage outer-rotor single-phase induction motor 100 includes an outer rotor 11, a stator core 12 disposed inside and concentric to the outer rotor 11, and a plurality of coils 13 would on the stator core 12. Through feeding a single-phase power signal to the coils 13 and configuring a phase split of a primary winding and a secondary winding of the stator core 12, the outer rotor 11 is able to generate an elliptical induction magnetic field for driving rotation of the outer rotor 11. However, since the elliptical induction magnetic field thus generated has a rotation speed vastly different from that of the outer rotor 11, the induction motor 100, as a result, has a relatively poor energy efficiency.

Taiwanese Patent Nos. M365605, M361170, M336346, and M296312 disclose motors that are applicable to ceiling fans and that adopt a motor mechanism comprised by a permanent magnetic core (or a magnetic ring), and a magnetism sensor component (or a Hall component). Due to the increasing trend in prices of magnets and rare earth elements, costs of such motors are expected to rise.

### SUMMARY OF THE INVENTION

Therefore, an object of the present invention is to provide an induction motor capable of alleviating the aforesaid drawbacks of the prior art.

According to the present invention, a multi-phase outer-rotor-type variable frequency induction motor for a ceiling fan comprises

a housing disposed to surround an axis, and including a plurality of blade-mounting parts disposed at angularly spaced apart positions with respect to the axis;

an outer rotor disposed in the housing, and including a stator-mounting part extending along the axis, and an outer rotor body surrounding the stator-mounting part and combined with the housing, the outer rotor body being formed with a plurality of slots that surround the stator-mounting part and that are disposed at angularly spaced apart positions with respect to the axis, and including a plurality of conductive elements respectively disposed in the slots;

a stator disposed in the stator-mounting part, and including a central shaft extending along the axis and pivotally connected to the housing, a stator core extending in radial directions from the central shaft, and a winding set, the stator core being formed with a plurality of winding slots that are disposed at angularly spaced apart positions with respect to the axis, the winding set being disposed to wind in the winding slots and being configured into a multi-phase winding arrangement; and

a control unit connected electrically to the winding set of the stator and operable to control frequency of a power signal fed by the control unit to the winding set.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram to illustrate a conventional induction motor for a ceiling fan;

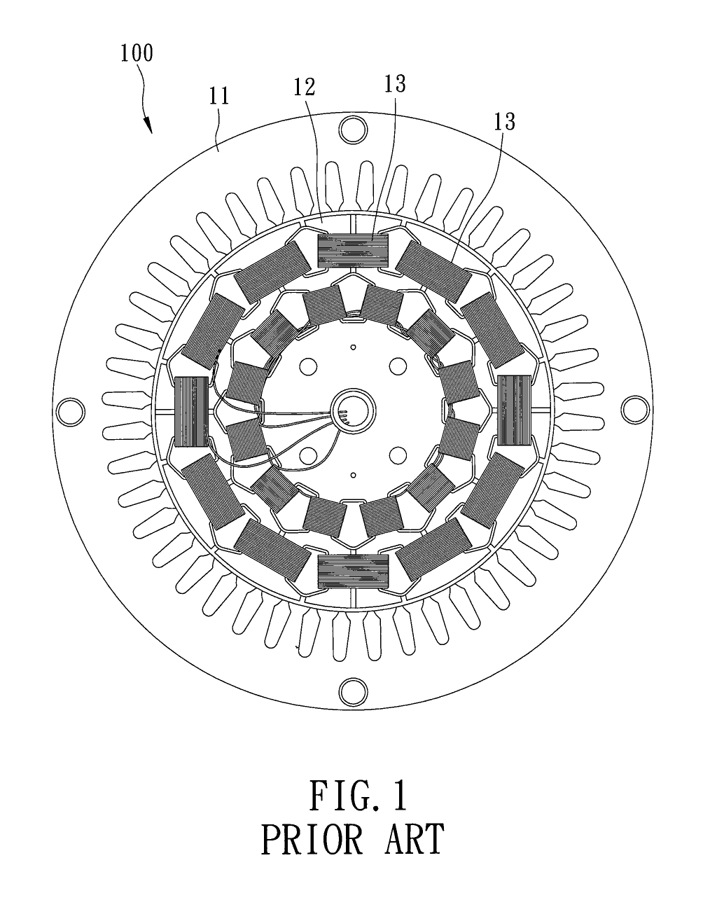

FIG. 2 is an exploded perspective view of the preferred embodiment of a multi-phase outer-rotor-type variable frequency induction motor for a ceiling fan, according to the present invention;

FIG. 3 is a schematic diagram to illustrate the multi-phase outer-rotor-type variable frequency induction motor; and

FIG. 4 is a block diagram to illustrate a control unit of the multi-phase outer-rotor-type variable frequency induction motor.

### DETAILED DESCRIPTION OF THE PREFERRED EMBODIMENT

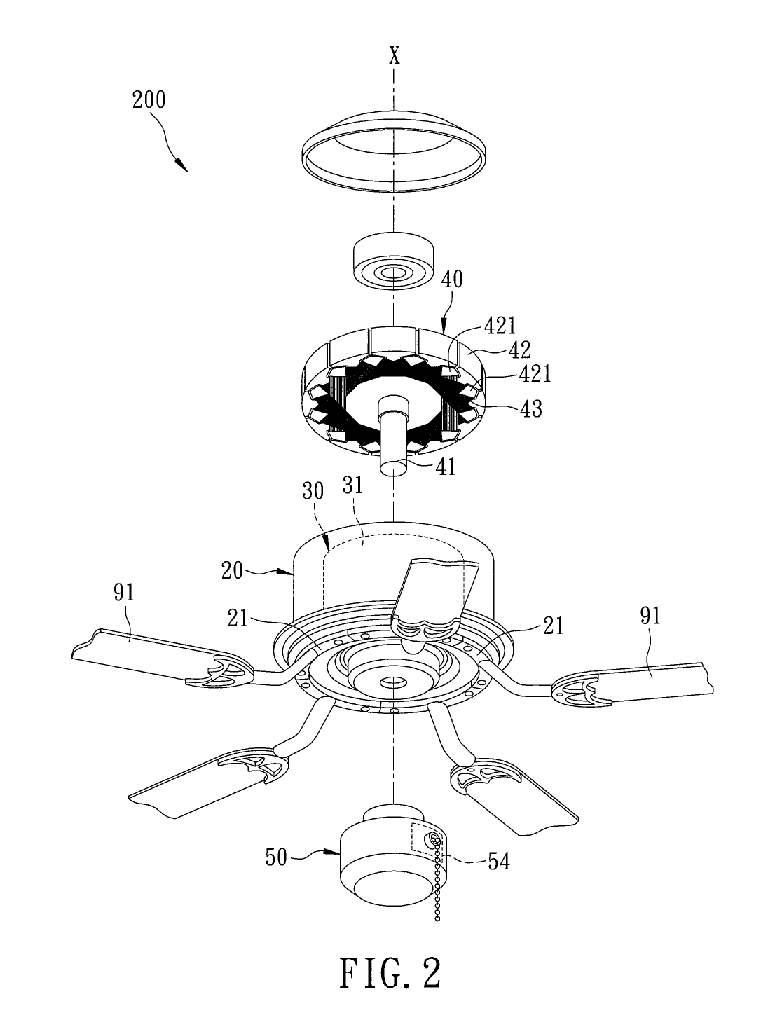

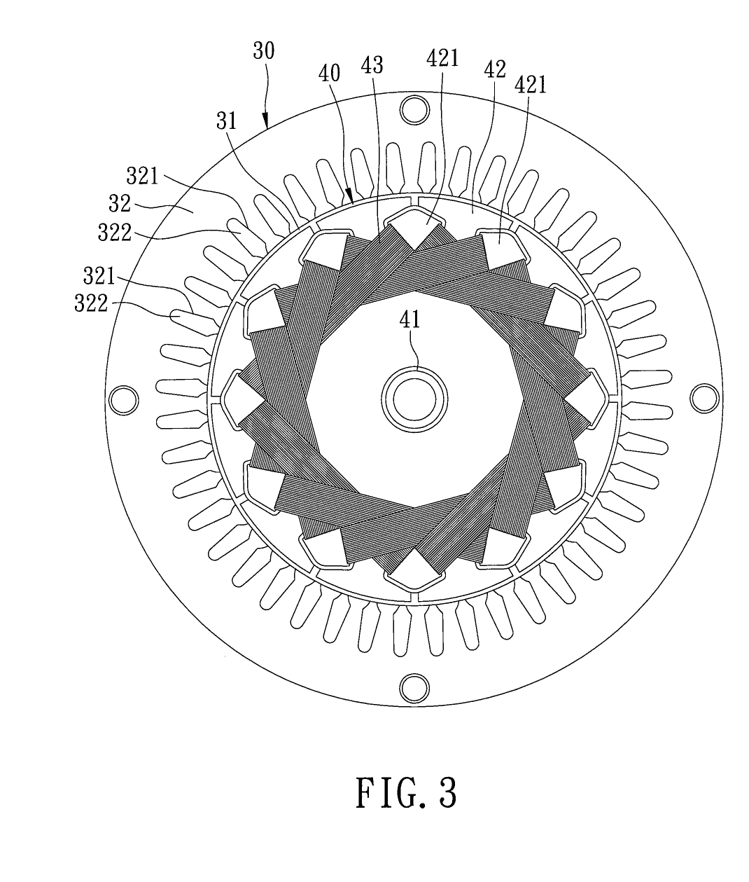

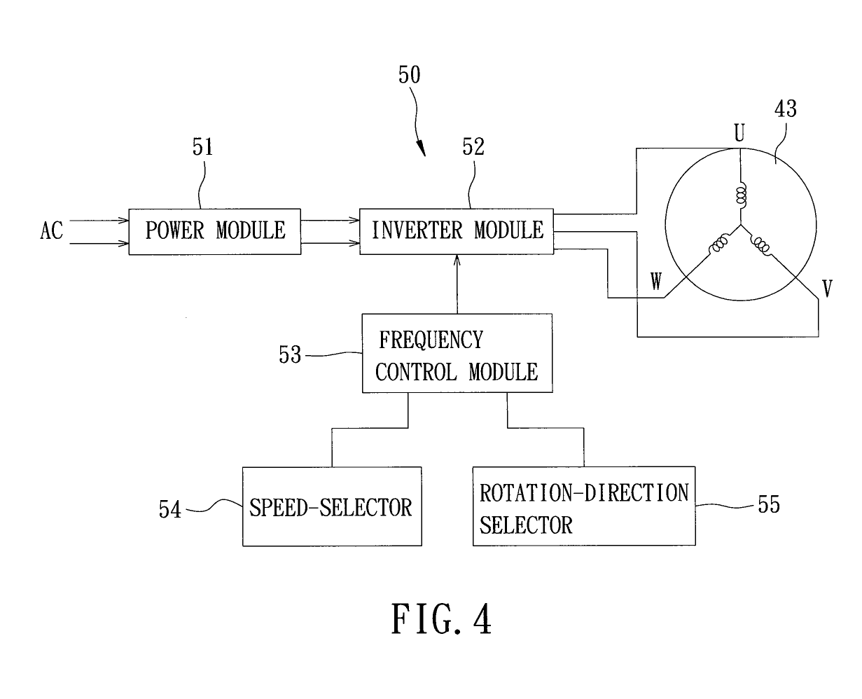

Referring to FIGS. 2 to 4, the preferred embodiment of a multi-phase outer-rotor-type variable frequency induction motor 200 according to the present invention is applicable to a ceiling fan, and includes a housing 20, an outer rotor 30, a stator 40, and a control unit 50.

The housing 20 is disposed to surround an axis “X”, and includes a plurality of blade-mounting parts 21 disposed at angularly spaced apart positions with respect to the axis “X”, and adapted for mounting of a plurality of fan blades 91, respectively.

The outer rotor 30 is disposed in the housing 20, and includes a stator-mounting part 31 extending along the axis “X”, and an outer rotor body 32 surrounding the stator-mounting part 31 and combined with the housing 20. In this embodiment, the stator-mounting part 31 is formed with a hole extending along the axis “X”.

The outer rotor body 32 is formed with a plurality of slots 321 that surround the stator-mounting part 31 and that are disposed at angularly spaced apart positions with respect to the axis “X”, and includes a plurality of conductive elements 322 disposed in the slots 321, respectively. The slots 321 are disposed such that geometric centers respectively bounded by the slots 321 are equidistant to the axis “X”, and that each of lines extending respectively from the axis “X” to the geometric centers of the slots 321 forms a first predetermined angle with an adjacent one of the lines extending respectively from the axis “X” to the geometric centers of the slots 321. In this embodiment, the conductive elements 322 are aluminium elements. In practice, the conductive elements 322 may be copper elements. However, the conductive elements 322 are not limited to such.

The stator 40 is disposed in the hole of the stator-mounting part 31, and includes a central shaft 41 extending along the axis “X” and pivotally connected to the housing 20, a stator core 42 extending in radial outward directions from the central shaft 41, and a winding set 43.

The stator core 42 is formed with a plurality of winding slots 421 that are disposed at angularly spaced apart positions with respect to the axis “X”. In this embodiment, the winding slots 421 are disposed such that geometric centers respectively bounded by the winding slots 421 are equidistant to the axis “X”, and that each of lines extending respectively from the axis “X” to the geometric centers of the winding slots 421 forms a second predetermined angle with an adjacent one of the lines extending respectively from the axis “X” to the geometric centers of the winding slots 421. The winding set 43 is disposed to wind in the winding slots 421 and is configured into a multi-phase winding arrangement. In this embodiment, the multi-phase winding arrangement is a three-phase winding arrangement. In practice, the winding set 43 may be any winding arrangement (e.g., two-phase, three-phase, or four-phase winding arrangement).

The control unit 50 is connected electrically to the winding set 43 of the stator 40, is operable to control frequency of a multi-phase frequency-converted power signal fed by the control unit 50 to the winding set 43, and includes: a power module 51 adapted to receive an external alternating-current power signal and to generate a supply power signal; an inverter module 52 connected electrically to the power module 51 for receiving the supply power signal therefrom, operable to generate a multi-phase frequency-converted power signal from the supply power signal, and connected electrically to the winding set 43 so as to provide the multi-phase frequency-converted power signal thereto; a frequency control module 53 connected electrically to the inverter module 52, and operable for controlling frequency of the multi-phase frequency-converted power signal based on a speed-select signal and a rotation-direction signal; a speed-selector 54 operable for generating the speed-select signal, and connected electrically to the frequency control module 53 for providing the speed-select signal thereto; and a rotation-direction selector 55 operable for generating the rotation-direction signal, and connected electrically to the frequency control module 53 for providing the rotation-direction signal thereto.

Accordingly, during operation of the induction motor 200, the control unit 50 generates the multi-phase frequency-converted power signal, and feeds the multi-phase frequency-converted power signal to the winding set 43 of the stator 40, which in turn generates a symmetric circular rotational magnetic field. The symmetric circular rotational magnetic field thus generated will induce an induction current in the outer rotor 30. The symmetric circular rotational magnetic field and the induction current will result in an electromagnetic force that drives the outer rotor 30 to rotate in the direction in which the symmetric circular rotational magnetic field rotates. In this embodiment, the speed-selector 54 is user-operable for altering the frequency of the multi-phase frequency-converted power signal, which in turn alters the speed at which the symmetric circular rotational magnetic field rotates, thereby altering a rotation speed of the outer rotor 30. The rotation-direction selector 55 is user-operable for reversing the direction in which the symmetric circular rotational magnetic field rotates, thereby reversing the direction in which the outer rotor 30 rotates.

Through the design of the multi-phase outer-rotor-type variable frequency induction motor 200 of this invention, a relatively low slip ratio and a relatively high operation efficiency may be achieved. Moreover, manufacturing of the induction motor 200 does not require a permanent magnet.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A multi-phase outer-rotor-type variable frequency induction motor for a ceiling fan, comprising:
a housing disposed to surround an axis, and including a plurality of blade-mounting parts disposed at angularly spaced apart positions with respect to the axis;
an outer rotor disposed in said housing, and including a stator-mounting part extending along the axis, and an outer rotor body surrounding said stator-mounting part and combined with said housing, said outer rotor body being formed with a plurality of slots that surround said stator-mounting part and that are disposed at angularly spaced apart positions with respect to the axis, and including a plurality of conductive elements respectively disposed in said slots;
a stator disposed in said stator-mounting part, and including a central shaft extending along the axis and pivotally connected to said housing, a stator core extending in radial directions from said central shaft, and a winding set, said stator core being formed with a plurality of winding slots that are disposed at angularly spaced apart positions with respect to the axis, said winding set being disposed to wind in said winding slots and being configured into a multi-phase winding arrangement; and
a control unit connected electrically to said winding set of said stator and operable to control frequency of a power signal fed by said control unit to said winding set.

2. The multi-phase outer-rotor-type variable frequency induction motor as claimed in claim 1, wherein said conductive elements of said outer rotor body are selected from copper elements and aluminum elements.

3. The multi-phase outer-rotor-type variable frequency induction motor as claimed in claim 1, wherein said multi-phase winding arrangement is one of a two-phase, three-phase, and four-phase winding arrangement.

4. The multi-phase outer-rotor-type variable frequency induction motor as claimed in claim 1, wherein said control unit includes:
a power module adapted to receive an external power signal and to generate a supply power signal;
an inverter module connected electrically to said power module for receiving the supply power signal therefrom, operable to generate a multi-phase frequency-converted power signal from the supply power signal, and connected electrically to said winding set so as to provide the multi-phase frequency-converted power signal thereto;
a frequency control module connected electrically to said inverter module, and operable for controlling frequency of the multi-phase frequency-converted power signal based on at least one of a speed-select signal and a rotation-direction signal;
a speed-selector operable for generating the speed-select signal, and connected electrically to said frequency control module for providing the speed-select signal thereto; and
a rotation-direction selector operable for generating the rotation-direction signal, and connected electrically to said frequency control module for providing the rotation-direction signal thereto.

5. The multi-phase outer-rotor-type variable frequency induction motor as claimed in claim 1, wherein said stator-mounting part is formed with a hole extending along the axis, and said stator is disposed in said hole of said stator-mounting part.

6. The multi-phase outer-rotor-type variable frequency induction motor as claimed in claim 1, wherein said slots are disposed such that geometric centers respectively bounded by said slots are equidistant to the axis, and that each of lines extending respectively from the axis to the geometric centers of said slots forms a first predetermined angle with an adjacent one of the lines extending respectively from the axis to the geometric centers of said slots.

7. The multi-phase outer-rotor-type variable frequency induction motor as claimed in claim 1, wherein said winding slots are disposed such that geometric centers respectively bounded by said winding slots are equidistant to the axis, and that each of lines extending respectively from the axis to the geometric centers of said winding slots forms a second predetermined angle with an adjacent one of the lines extending respectively from the axis to the geometric centers of said winding slots.
